(19) United States
(12) Patent Application Publication
(10) Pub. No.: US 2014/0262501 A1
(43) Pub. Date: Sep. 18, 2014

(54) DURABLE COPPER TO ALUMINUM WELDED CONNECTION

(71) Applicant: ALCOA INC., Pittsburgh, PA (US)

(72) Inventors: Israel Stol, Pittsburgh, PA (US); John W. Cobes, JR., Lower Burrell, PA (US); Gino Iasella, Gibsonia, PA (US); Rabindra Bhattacharyya, Export, PA (US)

(21) Appl. No.: 14/210,732

(22) Filed: Mar. 14, 2014

Related U.S. Application Data
(60) Provisional application No. 61/784,806, filed on Mar. 14, 2013.

(51) Int. Cl. H01R 4/02; H01R 43/02; H01R 43/058; H01B 1/02

(52) U.S. Cl. CPC H01R 4/02; H01B 1/02; H01R 43/02; H01R 43/058
USPC 174/94 R; 29/869; 29/871

(57) ABSTRACT

A welded electrical connection includes an aluminum electrical conductor welded to a copper electrical conductor. The copper electrical conductor and the aluminum electrical conductor form a butt joint, A ferrule is over the butt joint and attached to the copper electrical conductor and the aluminum electrical conductor. The ferrule is not directly attached to welded portions of the copper electrical conductor and the aluminum electrical conductor. In some embodiments, weld flash is between the butt joint and the ferrule.

### BACKGROUND

Aluminum provides a better conductivity to weight ratio than copper and is less expensive than copper. In some electrical applications, it desirable to use aluminum wire, cable or rod to take advantages of some of the above advantages of aluminum over copper. When aluminum is used, it may be necessary to join aluminum to copper wires, rods or other copper electrical conductors. As aluminum and copper are dissimilar metals, galvanic corrosion can occur in the presence of an electrolyte and these connections can become unstable over time.

### SUMMARY

In one embodiment, an apparatus comprises: a copper electrical conductor; an aluminum electrical conductor welded to the copper electrical conductor, the copper electrical conductor and the aluminum electrical conductor forming a butt joint; and a ferrule over the butt joint and attached to the copper electrical conductor and the aluminum electrical conductor.

For the purposes of this specification, a ferrule is a device that provides strain relief to the welded butt joint. In some embodiments, the ferrule is comprised of metal.

For the purposes of this specification, a butt joint is a joint formed by attaching together ends of the conductors. The end of one conductor can be at any angle with respect to the end of the conductor to which it is being joined, for example at a 90 degree angle or at a 180 degree angle as shown in the figures.

In some embodiments, the ferrule is not directly attached to welded portions of the copper electrical conductor and the aluminum electrical conductor.

In some embodiments, weld flash is between the butt joint and the ferrule. In some embodiments, the ferrule is designed to include a recess, which lets the welding flash develop during welding and later locks against the welding flash to further augment the load sharing between the different parts of the joint.

In some embodiments, the ferrule has a first end and a second end, wherein the first end is mechanically locked to the copper electrical conductor and the second end is mechanically locked to the aluminum electrical conductor. In some embodiments, the first end of the ferrule is crimped to the copper electrical conductor and the second end of the ferrule is crimped to the aluminum electrical conductor. In some embodiments, the first and the second end of the ferrule have teeth and the teeth penetrate the copper electrical conductor and the aluminum electrical conductor.

In some embodiments, the copper electrical conductor comprises one of: a rod and a bundle of wires. In some embodiments, the aluminum electrical conductor comprises one of: a rod and a bundle of wires.

In some embodiments, the copper electrical conductor and the aluminum electrical conductor each have a longitudinal axis and the longitudinal axis of the copper electrical conductor is aligned with the longitudinal axis of the aluminum electrical conductor. When the longitudinal axis of the copper electrical conductor is aligned with the longitudinal axis of the aluminum electrical conductor, the angle formed by the butt joint between copper electrical conductor and the aluminum electrical conductor is between 175 degrees and 185 degrees.

In some embodiments, the ferrule has a first end and a second end and the apparatus further comprises an adhesive sealing the first end of the ferrule to the copper electrical conductor and the second end of the ferrule to the aluminum electrical conductor.

In some embodiments, the apparatus includes a dielectric sleeve over the butt Joint. A dielectric sleeve is a sleeve that that conducts a negligible amount of electricity. In some embodiments, the dielectric sleeve has an electrical conductivity of less than a millionth (10-6) of a siemens,

A method comprises: welding a copper electrical conductor to an aluminum electrical conductor such that a butt joint is formed between the copper electrical conductor and the aluminum electrical conductor; and attaching a first end of a ferrule to the copper electrical conductor and a second end of the ferrule to the aluminum electrical conductor such that the ferrule is not directly attached to welded portions of the copper electrical conductor and the aluminum electrical conductor.

In some embodiments, the method Includes placing the ferrule over a portion of the aluminum electrical conductor to be welded before welding the copper electrical conductor to the aluminum electrical conductor. In some embodiments, the method includes placing the ferrule over a portion of the copper electrical conductor to be welded before welding the copper electrical conductor to the aluminum electrical conductor.

In some embodiments of the method, the step of attaching a first end of the ferrule to the copper electrical conductor and the second end of the ferrule to the aluminum electrical conductor comprises crimping the first end of the ferrule to the copper electrical conductor and crimping the second end of the ferrule to the aluminum electrical conductor.

In some embodiments of the method, the copper electrical conductor and the aluminum electrical conductor each have a longitudinal axis and the longitudinal axis of the copper electrical conductor is aligned with the longitudinal axis of the aluminum electrical conductor.

In some embodiments of the method includes sealing the first end of the ferrule to the copper electrical conductor and the second end of the ferrule to the aluminum electrical conductor.

In some embodiments the method includes, placing a dielectric sleeve over the butt joint.

The aluminum conductor is comprised of aluminum or an aluminum alloy, for example AA 1100 or AA1350.

### DESCRIPTION OF THE FIGURES

Reference is made to the following detailed description of exemplary embodiments considered in conjunction with the accompanying drawings, wherein:

FIG. 1A is a cross section view of a copper electrical conductor welded to an aluminum electrical conductor according to one embodiment;

FIG. 1B is a cross section view of a copper electrical conductor welded to an aluminum electrical conductor according to another embodiment;

FIG. 2 is a partial side view of the embodiment shown in FIG. 1A; and

FIG. 3 is a cross section view of a copper electrical conductor welded to an aluminum electrical conductor according to a further embodiment.

### DESCRIPTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and Is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The apparatus shown in FIG. 1A includes a copper electrical conductor 10 and an aluminum electrical conductor 12 welded to the copper electrical conductor. The copper electrical conductor 10 and the aluminum electrical conductor 12 form a butt joint 14. A ferrule 16 is over the butt joint 14 and attached to the copper electrical conductor 10 and the aluminum electrical conductor 12. The ferrule 16 is not directly attached to welded portions 18 of the copper electrical conductor 10 and the aluminum electrical conductor 12. Weld flash 20 is between the butt joint 14 and the ferrule 16. The ferrule 16 is designed to include a recess 21, which lets the welding flash 20 develop during welding and later locks against the welding flash 20 to further augment the load sharing between the different parts of the joint 14.

The first end 22 of the ferrule 16 is mechanically locked to the copper electrical conductor 10 and the second end 24 of the ferrule 16 is mechanically locked to the aluminum electrical conductor 12. The first end 22 of the ferrule 16 is crimped to the copper electrical conductor 10 and the second end 24 of the ferrule 16 is crimped to the aluminum electrical conductor 12. The first and the second end, 22 and 24, respectively, of the ferrule 16 have teeth 26 and the teeth penetrate the copper electrical conductor 10 and the aluminum electrical conductor 12. The teeth 26 are crimped into the aluminum strands of the aluminum electrical conductor 12. An adhesive 40 seals the first end 22 of the ferrule 16 to the copper electrical conductor 10 and the second end 24 of the ferrule 16 to the aluminum electrical conductor 12. The apparatus includes a dielectric sleeve 42 over the butt joint 14. A further insulator 44 is over the aluminum electrical conductor 12.

In the embodiment shown in FIG. 1A, the copper electrical conductor 10 comprises a rod and the aluminum electrical conductor 12 comprises a bundle of wires.

The copper electrical conductor and the aluminum electrical conductor each have a longitudinal axis and the longitudinal axis 36 of the copper electrical conductor 10 is aligned with the longitudinal axis 38 of the aluminum electrical conductor 12. In the embodiment shown in FIG. 1A, the angle formed by the butt joint 14 between copper electrical conductor 10 and the aluminum electrical conductor 12 is between 175 and 185 degrees, specifically, 180 degrees.

The embodiment shown in FIG. 1B is similar to that shown in FIG. 1A except the ferrule 15 has a taper 17.

FIG. 2 is a different view of the embodiment shown in FIG. 1A. Rounded (sinusoidal) teeth 46 external to the copper electrical conductor 10 are forcibly crimped into ferrule (FIG. 1A). The forceful engagement between these teeth 46 and the ferrule, mechanically “locks” them together and thus transmits both static and cyclic (e.g. vibrations) types of loads from the ferrule to the copper electrical conductor 10. Rounded indentations 48 in the outer aluminum strands of the aluminum electrical conductor 12 are formed by forcibly crimping the rounded (sinusoidal) teeth 26 (FIG. 1A) inside the ferrule 16 (FIG. 1A) against the strands. The forceful engagement between these teeth 26 and the aluminum electrical conductor 12 mechanically locks them together and thus transmits both static and cyclic (e.g. vibrations) types of loads from the aluminum electrical conductor 12 to the ferrule 16.

Another embodiment is shown in FIG. 3. The apparatus shown in FIG. 3 includes a copper electrical conductor 50 and an aluminum electrical conductor 52 welded to the copper electrical conductor. The copper electrical conductor 50 and the aluminum electrical conductor 52 form a butt joint 54. A ferrule 56 is over the butt joint 54 and attached to the copper electrical conductor 50 and the aluminum electrical conductor 52. The ferrule 56 is not directly attached to welded portions 58 of the copper electrical conductor 50 and the aluminum electrical conductor 52. Weld flash 60 is between the butt joint 54 and the ferrule 56. The ferrule 56 is designed to include a recess, which lets the welding flash 60 develop during welding and later locks against the welding flash 60 to further augment the load sharing between the different parts of the joint 54.

The first end 62 of the ferrule 56 is mechanically locked to the copper electrical conductor 50 and the second end 64 of the ferrule 56 is mechanically locked to the aluminum electrical conductor 52. The ferrule 56 is integral with the pigtail type copper electrical conductor 50. The apparatus includes a dielectric sleeve 82 over the butt joint 54. A further insulator 84 is over the aluminum electrical conductor 52,

In the embodiment shown in FIG. 3, the copper electrical conductor 50 comprises a rod and the aluminum electrical conductor 52 comprises a rod,

The copper electrical conductor and the aluminum electrical conductor each have a longitudinal axis and the longitudinal axis 76 of the copper electrical conductor 50 is aligned with the longitudinal axis 78 of the aluminum electrical conductor 52. In the embodiment shown in FIG. 3, the angle formed by the butt joint 54 between copper electrical conductor 50 and the aluminum electrical conductor 52 is between 175 and 185 degrees, specifically, 180 degrees.

Some embodiments of the apparatus include a weld between aluminum and copper conductors, while at the same time also including a separate complementary mechanical connection, a jacket or ferrule, which will carry and transmit the static loads (i.e. weight of the conductors, elastic loads from bent conductors), thus removing the lion's share of these loads from the current conducting weld and minimizing the strains (i.e. vibration, etc.) on the weld. At the same time, the separate mechanical connector will also isolate via distance and dampen the vibrating and thermo-mechanical (i.e. expansion and contraction) fluctuating loads away from the weld (FIGS. 1-3).

In some embodiment, the jacket is integral to the copper terminal (FIG. 3) and firmly connected to both the end of the aluminum conductor and copper terminal, but is not directly connected to the current transmitting weld, underneath it (FIGS. 1-3). By having the aluminum jacket transmit the static and cyclic loads between the aluminum and copper parts, the lion's share of these loads are removed from the current conducting weld (FIGS. 1-3). In other words, the aluminum jacket isolates via distance from the weld direct mechanical connection to the ends of the aluminum conductor and copper terminal and no direct connection with the weld) and dampens the static, cyclic and thermo-mechanical (e.g. expansion and contraction) loads by transmitting them away from the current conducting weld.

In some embodiments, for applications where the aluminum connector would be suspended (e.g. power transmission lines) in air, the proposed new electric connections have a built in mechanical redundancy for situations where portions of the electric connectors fail. In some embodiments the ferrule or jackets will be capable of temporarily withstanding the weight of the “aluminized” conductors until they are repaired or replaced.

In some embodiments, the welded connection can be produced with Solid State or Fusion Based Welding processes, which include: Flash Welding, Inertia or Direct Friction Welding, Ultrasonic Welding, Resistance-Upset Welding, High Frequency Welding, Cold-Upset Welding, Friction Welding, Electron Beam welding, Gas Tungsten Arc Welding, Soldering and Brazing processes.

In some embodiments, to maximize the current transmission through the current conducting welds, the cross-sectional ends of the aluminum conductor (e.g. solid rod or strands) are welded to the copper terminals.

In some embodiments, the load transmitting jacket can either be separate from the aluminum conductor and copper terminal, prior to crimping the jacket onto these parts (FIGS. 1 and 2) or be integral with the copper terminal (FIG. 3).

In some embodiments, the proposed load transmitting jacket (Ferrule), between the aluminum conductor and copper conductor, e.g. terminals, is to be made of 1xxx (1100), 6xxx (6061), 3xxx (3003) series aluminum or any other aluminum alloys (e.g. 7005, 2099), materials (e.g. Tough-Pitch or Oxygen-Free Copper) or a combination of materials (e.g. copper/aluminum, such as copper outside jacket and aluminum inside jacket).

In some embodiments, aluminum conductor and the copper conductor are co-axial with each other (e.g. Pigtails, in FIG. 3). In some embodiments, the conductors are at an angle other than 180 degrees to each other.

In some embodiments, the aluminum jacket is mechanically locked to the aluminum conductor (e.g. in the form of rod, wire or strands) and copper conductor (e.g. terminal) by any mean that enables the jacket to carry and dampen the static and cyclic loads off or away from the current conducting weld. These means include: forceful crimping (FIGS. 1 and 2), use of threaded connections on the copper terminal, braiding the aluminum strands into special features (e.g. multiple holes) in the aluminum jacket.

In some embodiments, the inner diameter of the ferrule has teeth that are designed to be forcibly embedded into the outer diameter of a bare, i.e. after the electric coating has been removed, aluminum conductor. In some embodiments, the copper conductor has teeth that are designed to be forcibly embedded into the inner diameter of the aluminum jacket. In order to minimize the stress-rising effects of sharp indentations in the aluminum conductor's ends by the aluminum jacket (FIGS. 1 and 2) and within the aluminum jacket from the corresponding teeth in the copper terminal, In some embodiments, the teeth on these parts have a sinusoidal shape.

In some embodiments, the ends of the jackets that go over the electric isolating coats are tapered (FIG. 1B).

In some embodiments, the aluminum jackets have an extra space that will act as a reservoir for the welding flash (FIG. 1A). In some embodiments, welding flash is accommodated into the extra space or pocket to allow the aluminum conductor and the copper conductor to be driven together. In some embodiments, the welding flash is accommodated into a pocket so as not to contaminate the electrical connection with undesired debris, e.g. oxides, etc. In some embodiments, the welding flash driven and conforming into the pocket contributes to the mechanical strength/retention of the joint.

In some embodiments, sealing-adhesive or heat expandable seals are placed and thermally activated at the spaces between the ends of the ferrule and the electrical insulator surrounding the aluminum conductor and copper conductor. In some embodiments, a heat shrinkable dielectric sleeve will be placed and shrunk over welded joints (FIG. 1A).

By the way of example only, the following production sequence of the electric connection shown in FIG. 1, in some embodiments, will consist of the following steps:

i. Remove the insulating coating to expose the aluminum strands.

ii. Slip the aluminum jacket over the aluminum strands.

iii. Forcibly crimp the aluminum jacket onto the “exposed” (w/o electric coating) aluminum strands on the OD of the “bundle” (FIG. 2).

iv. Place the end of the aluminum conductor with the aluminum jacket crimped onto it, into the chuck end of a Flash-Welding machine (or alternatively into the stationary, non-rotating chuck of an Inertia Friction Welding) and actuate the closing of the welding machine's end onto the OD of the aluminum jacket, crimped over the aluminum strands.

v. Place the copper terminal into the other clamping end of the Flash-Welding machine (or the rotating chuck of the Inertia Friction Machine).

vi. Activate the Flash-Welding cycle (or Inertia Friction Welding cycle) and weld the aluminum strands directly into the copper terminal (FIG. 4 for an example of an Inertia Friction Welded sample).

vii. De-actuate the welding machine's chucks and remove the welded part.

viii. Forcibly crimp the aluminum jacket over the copper terminal with its “teeth”.

ix. Inspect and test (e.g. electric resistance, pull-test) the completed electric connection for compliance with its specification.

Although the present invention has been described in considerable detail with reference to certain versions thereof, other versions are possible. Therefore, the spirit and scope of the appended claims should not be limited to the description of the versions contained herein.

All features disclosed In the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means or step for” clause as specified in 35 U.S.C. §112.

1. An apparatus comprising:
a. a copper electrical conductor;
b. an aluminum electrical conductor welded to the copper electrical conductor, the copper electrical conductor and the aluminum electrical conductor forming a butt joint; and
c. a ferrule over the butt joint and attached to the copper electrical conductor and the aluminum electrical conductor.

2. The apparatus of claim 1 wherein the ferrule is comprised of metal.

3. The apparatus of claim 1 wherein the ferrule is not directly attached to welded portions of the copper electrical conductor and the aluminum electrical conductor.

4. The apparatus of claim 1 wherein weld flash is between the butt joint and the ferrule.

5. The apparatus of claim 1 wherein the ferrule has a first end and a second end, wherein the first end is mechanically locked to the copper electrical conductor and the second end is mechanically locked to the aluminum electrical conductor.

6. The apparatus of claim 1 wherein the first end of the ferrule is crimped to the copper electrical conductor and the second end of the ferrule is crimped to the aluminum electrical conductor.

7. The apparatus of claim 1 wherein the first and the second end of the ferrule have teeth and the teeth penetrate the copper electrical conductor and the aluminum electrical conductor.

8. The apparatus of claim 1 wherein the copper electrical conductor comprises one of: a rod and a bundle of wires.

9. The apparatus of claim 1 wherein the aluminum electrical conductor comprises one of: a rod and a bundle of wires.

10. The apparatus of claim 1 wherein the copper electrical conductor and the aluminum electrical conductor each have a longitudinal axis and the longitudinal axis of the copper electrical conductor is aligned with the longitudinal axis of the aluminum electrical conductor.

11. The apparatus of claim 1 wherein the ferrule has a first end and a second end and the apparatus further comprises an adhesive sealing the first end of the ferrule to the copper electrical conductor and the second end of the ferrule to the aluminum electrical conductor.

12. The apparatus of claim 1 further comprising a dielectric sleeve over the butt joint.

13. A method comprising:
a. welding a copper electrical conductor to an aluminum electrical conductor such that a butt joint is formed between the copper electrical conductor and the aluminum electrical conductor;
b. attaching a first end of a ferrule to the copper electrical conductor; and
c. attaching a second end of the ferrule to the aluminum electrical conductor
d. wherein the ferrule is not directly attached to welded portions of the copper electrical conductor and the aluminum electrical conductor.

14. The method of claim 13 further comprising placing the ferrule over a portion of the aluminum electrical conductor to be welded before welding the copper electrical conductor to the aluminum electrical conductor.

15. The method of claim 13 further comprising placing the ferrule over a portion of the copper electrical conductor to be welded before welding the copper electrical conductor to the aluminum electrical conductor.

16. The method of claim 13 further comprising placing the ferrule over a portion of the aluminum electrical conductor to be welded and placing the ferrule over a portion of the copper electrical conductor to be welded before welding the copper electrical conductor to the aluminum electrical conductor.

17. The method of claim 13 wherein the step of attaching a first end of the ferrule to the copper electrical conductor and the second end of the ferrule to the aluminum electrical conductor comprises crimping the first end of the ferrule to the copper electrical conductor and crimping the second end of the ferrule to the aluminum electrical conductor.

18. The method of claim 13 wherein the copper electrical conductor and the aluminum electrical conductor each have a longitudinal axis and the longitudinal axis of the copper electrical conductor is aligned with the longitudinal axis of the aluminum electrical conductor.

19. The method of claim 13 further comprising sealing the first end of the ferrule to the copper electrical conductor and the second end of the ferrule to the aluminum electrical conductor.

20. The method of claim 13 further comprising placing a dielectric sleeve over the butt joint.
